(19) United States
(12) Patent Application Publication
(10) Pub. No.: US 2023/0399145 A1
(43) Pub. Date: Dec. 14, 2023

(54) Waste Bags with Different Design Configurations to Alert a User of the Remaining Supply

(71) Applicants: Saul Lopez, Houston, TX (US); Reginaldo Lopez, Houston, TX (US); Erik Lopez, Houston, TX (US)

(72) Inventors: Saul Lopez, Houston, TX (US); Reginaldo Lopez, Houston, TX (US); Erik Lopez, Houston, TX (US)

(21) Appl. No.: 18/333,617

(22) Filed: Jun. 13, 2023

Related U.S. Application Data
(60) Provisional application No. 63/351,493, filed on Jun. 13, 2022.

(51) Int. Cl. B65D 33/00; B65F 1/00

(52) U.S. Cl. CPC B65D 33/004; B65D 33/002; B65F 1/0006; B65F 2210/138; B65F 2240/136

(57) ABSTRACT

A roll or set of waste bags is configured with a design-changing scheme that alerts a user about the number or approximate number of bags remaining in their set of waste bags. The design-changing scheme may utilize colors that alert the user that the specific waste bag roll is almost depleted. For example, using colors that differ from the remaining bags, such as green, orange, yellow, and/or red, can indicate to the user that they should either order more waste bags or refill their waste bag holder. In other implementations, a progressive color-changing scheme may be put in place, such that the first or second bag in the roll start showing a partial red portion to indicate to the user approximately how many bags they have left. The amount of red, or other colors, on the bag, may grow incrementally up to the last bag in the set.

### CROSS-REFERENCES TO RELATED APPLICATIONS

This Non-Provisional Utility Patent Application claims the benefit of and priority to U.S. Provisional Application Ser. No. 63/351,493, filed Jun. 13, 2022, entitled “Stoplight Color Scheme Sanitary Waste Bags,” the entire contents of which are hereby incorporated herein by reference. This Non-Provisional Utility Patent Application is related to co-pending Design application Ser. No.______, filed contemporaneously herewith on Jun. 13, 2023, entitled “Waste Bags with Different Design Configurations,” the entire contents of which are hereby incorporated herein by reference.

### BACKGROUND

Dog and pet owners typically purchase waste bags specifically tailored to hold their dog's bowel movement. Occasionally, pet owners can be caught off guard if their waste bag holder is empty before they order or refill their waste bag holding device. This can cause unnecessary stress in what should be a simple situation.

### SUMMARY

A roll or set of waste bags is configured with a design-changing scheme that alerts a user about the number or approximate number of bags remaining in their set of waste bags. In typical implementations, the design-changing scheme may utilize colors that alert the user that the specific waste bag roll is almost depleted. For example, using colors that differ from the remaining bags, such as green, orange, yellow and/or red, can indicate to the user that they should either order more waste bags or refill their waste bag holder. In other implementations, a progressive color-changing scheme may be put in place, such that the first or second bag in the roll start showing a partial red portion to indicate to the user approximately how many bags they have left. The amount of red, or other colors, on the bag, may grow incrementally until the user reaches the last bag, which may be substantially or fully red.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIGS. 1-3 show illustrative representations of a rolled-up set of waste bags;

FIG. 4 shows an illustrative representation of a user pulling a single waste bag from a waste bag holder;

FIG. 5 shows an illustrative representation of the waste bag roll unrolling;

FIG. 6 shows an illustrative representation of a different color waste bag within the set of waste bags;

FIGS. 7 and 8 show illustrative representations of the final three waste bags in the waste bag roll;

FIG. 9 shows an illustrative schematic representation of one embodiment of a waste bag roll using different color waste bags; and

FIG. 10 shows an illustrative schematic representation of a progressive color change for the waste bag roll.

Like reference numerals indicate like elements in the drawings. Elements are not drawn to scale unless otherwise indicated.

### DETAILED DESCRIPTION

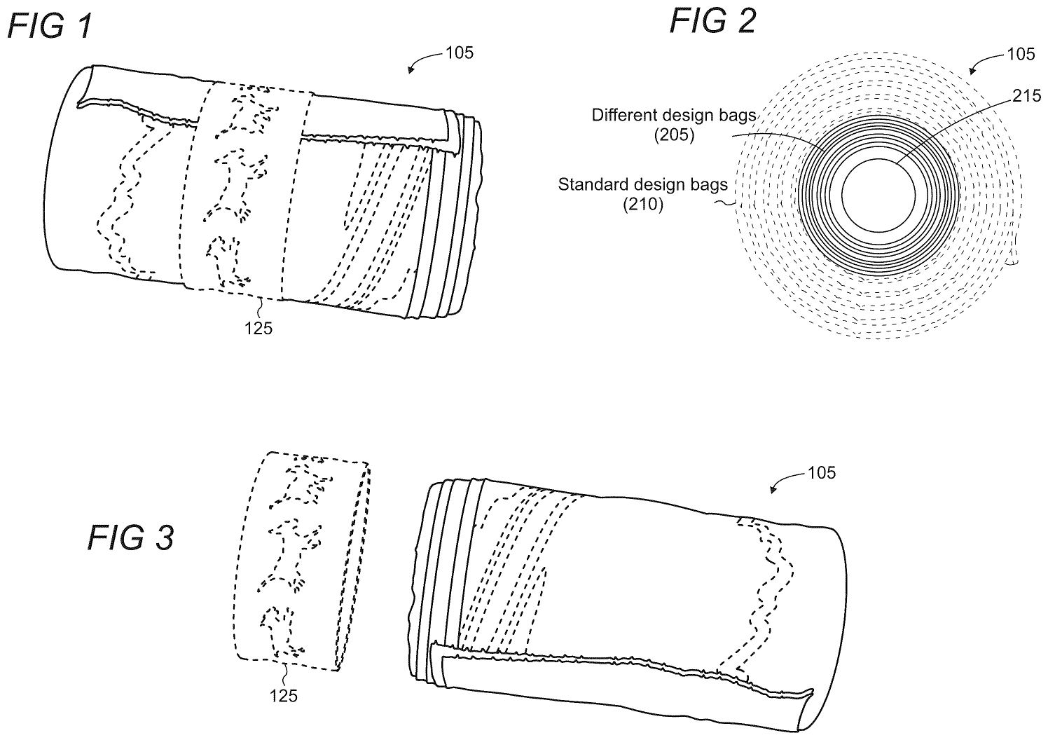

FIGS. 1-3 show illustrative representations of a set or roll of waste bags 105 that are connected to each other along a perforated edge that disengages responsive to a user pulling on the next waste bag in line. The waste bags may initially come wrapped in a paper 125 to prevent the bags from unrolling and can be accessed upon the user removing the paper 125 from the roll. Alternatively, the bags may be lightly taped to prevent unraveling. The waste bags are wrapped around a cylindrical component 215, which may be comprised of cardboard, plastic, or other material, that provides the structural basis upon which the bags are wrapped.

In typical implementations, the waste bags leverage design changes throughout the set or roll of bags to inform the user about the number of bags remaining in the roll. For example, the set of waste bags 105 may have standard design bags 210 that are consistently designed among each other, such as all being the same color or having the same overall design. Discussion about the bag's design may include the bag's color, artwork on the bag's exterior, size, shape, or any combination thereof. The standard design bags may be the initial set of bags that is accessible to the user upon unraveling the roll 105. As the user progresses through the roll of bags to pick up their pet's waste, different design bags 205 are put toward the end of the roll to alert the user that the number of bags in the roll is depleting and the user should either obtain a refill or purchase new waste bags soon. The different design bags may be the ending set of bags on the roll 105 that begin indicating to the user that they are running low on supply in the current roll. This way, the user isn't surprised when the last bag is present, and they may be unable to pick up their pet's waste. The design scheme changes at least between the initial (standard design) and ending (different design) set of bags.

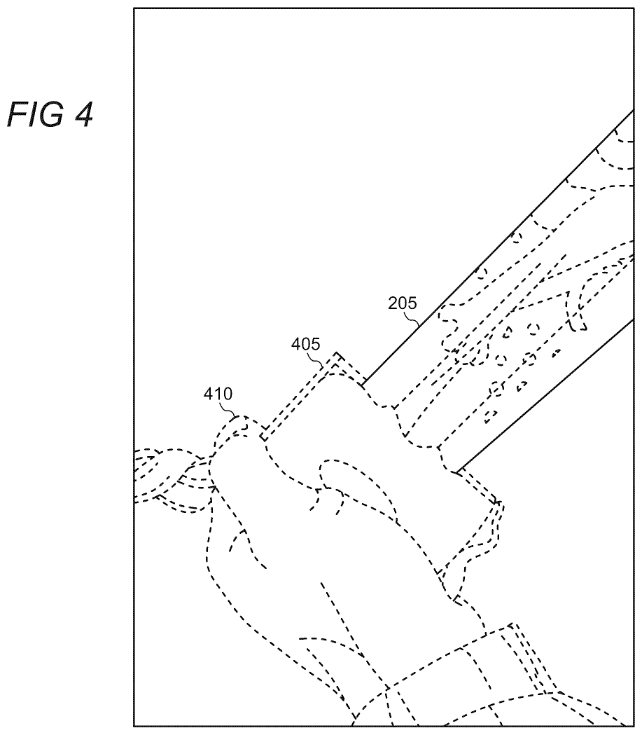

FIG. 4, for example, shows an illustrative representation in which the user 410 uses a waste bag holder 405 to remove standard and different color waste bags 205 and 210. Occasionally, the holder may make it difficult for the user to definitively know how many bags are remaining since the holder obstructs the user's view of the holder's contents, making the different designed waste bags 205 helpful to the user.

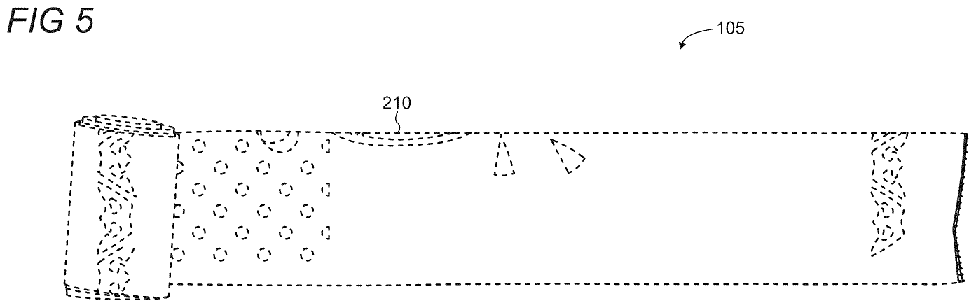

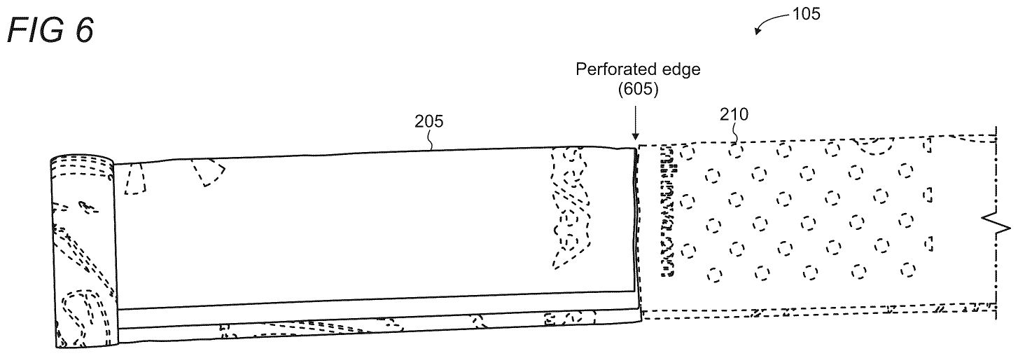

FIG. 5 shows an illustrative representation in which the roll of waste bags 105 unrolls to see the standard design bags 210. As the set continues to unroll, additional waste bags become accessible. Waste bags are separated at perforated edges between waste bags that detach upon a user pulling the next waste bag in line from the subsequent waste bag. The roll continues like this until the final bag is used. FIG. 6, for example, shows the perforated edge 605 between the different designed waste bag 205 from the standard design waste bag 210. This perforated edge may apply to the separation of all the waste bags in the roll. As the roll continues to unwind, the design change may continue to further alert the user regarding the number of remaining bags. In this example, green may be used for the first bag to indicate to the user three bags are remaining, yellow may be used to indicate to the user two bags are remaining, and red may be used to alert the user that a single bag is remaining and they should re-stock on waste bags. In other implementations, each of the different design waste bags 205 may be red to indicate to the user they should refill.

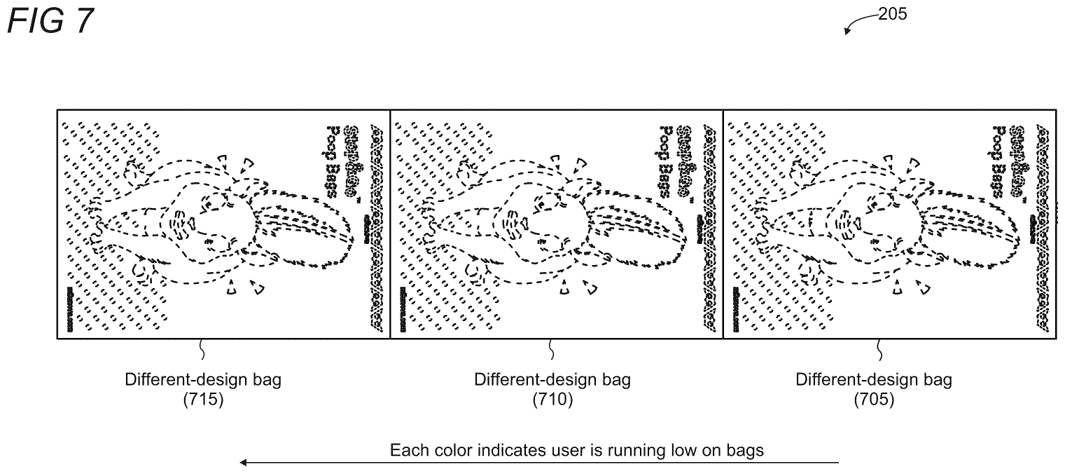

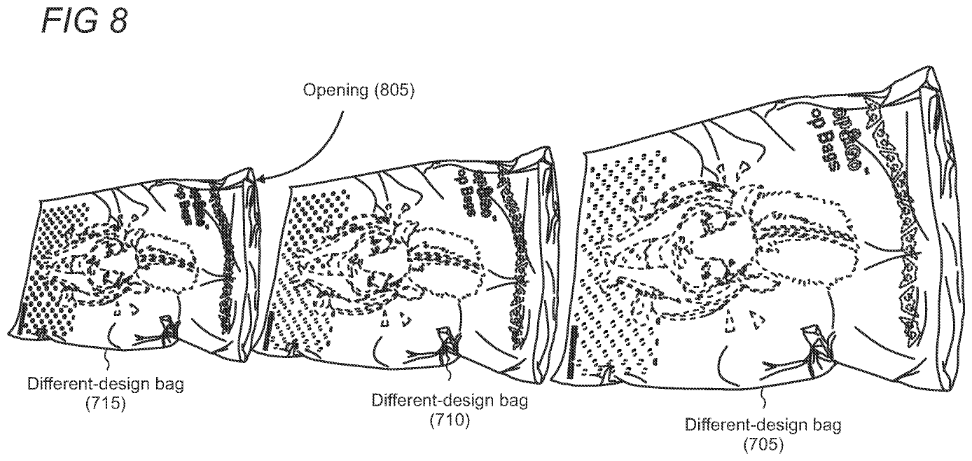

FIGS. 7 and 8 show illustrative representations in which the final three waste bags, the different design waste bags 205, are shown in a completely unfolded position. For clarity in specifying each waste bag, the last three different design waste bags are indicated as reference numeral 705, 710, and 715. As shown, each color indicates to the user the number of bags remaining in the roll. Each bag, when detached from the adjacent waste bag 205 or 210, has an opening 805 to enable a user to open the waste bag and put in their pet's waste. In other implementations, the waste bags may be used for other purposes, such as throwing out garbage, recyclables, etc.

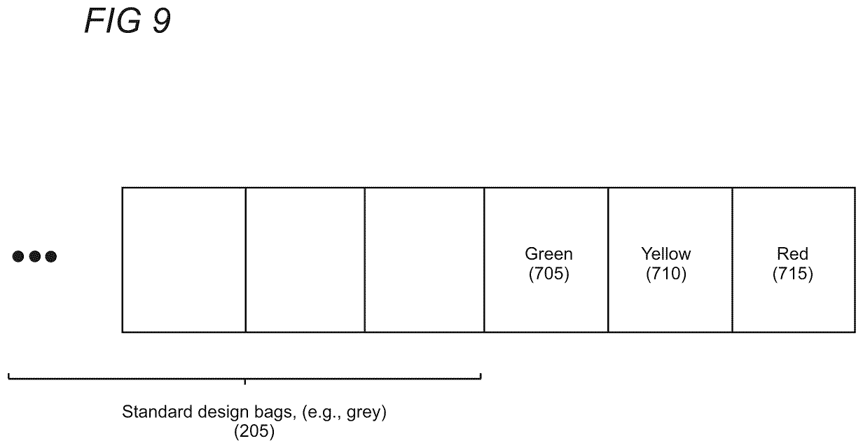

FIG. 9 shows an illustrative schematic representation in which the first set of standard design waste bags 205 are all consistently designed, such as all having the same color (e.g., grey). Any number of the standard design bags may be in the roll, such as five, 10, 20, etc. The last three waste bags in the set are the different design bags 205, which may be green, 705, yellow 710, and red 715.

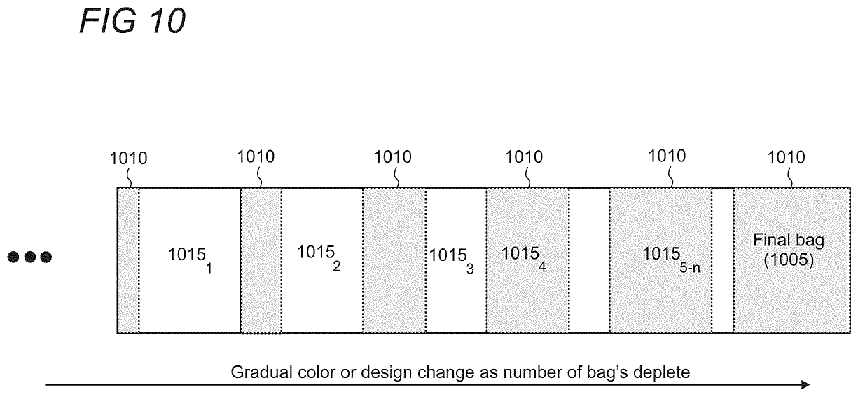

FIG. 10 shows an illustrative schematic representation in which the roll of waste bags 105 gradually changes from the first or second bag onward to provide a more detailed and precise indication as to the number of bags remaining. As shown, the amount of color change for the waste bags 1015 (in grey) gradually increases over each bag's surface area as the roll gets to the final bag 1005, at which point the bag's color is completely changed. The color change portion 1010 may be consistently red from the first bag in line 1015 to the final bag 1005, may be multi-colored, may change from green to yellow and to red, or any number of scenarios. Although a progressively changed color is shown in FIG. 10, other design changes may be possible. For example, a logo or artwork on the bags may gradually disappear or appear as the set of bags 105 gets closer to the final bag 1005. Alternatively, a combination of the artwork's gradual development or disappearance may be used in combination with the color-changing scheme.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A set of waste bags, comprising:
an initial set of waste bags which share a common design scheme; and
an ending set of waste bags, connected to the initial set, that have a different design scheme relative to the initial set of waste bags.

2. The set of waste bags of claim 1, wherein the ending set of waste bags include three different waste bags each with a different design-scheme relative to each other.

3. The set of waste bags of claim 2, wherein the initial set of waste bags all have an identical design-scheme.

4. The set of waste bags of claim 3, wherein the design-scheme pertains to color.

5. The set of waste bags of claim 4, wherein waste bags in the set are connected on at least one side to an adjacent waste bag via a perforated edge.

6. A set of waste bags, comprising:
a cylindrical center; and
a roll of waste bags, each connected on at least one side to an adjacent waste bag via a perforated edge, wherein a beginning waste bag in the roll gradually changes its design up to a final waste bag in the roll, in which the final waste bag's design is completely changed relative to an initial waste bag in the roll.

7. The set of waste bags of claim 6, wherein the gradual design change is the waste bag's gradually changing color from the initial waste bag to a complete color change of the final waste bag.
